(19) United States
(12) Patent Application Publication
(10) Pub. No.: US 2024/0301929 A1
(43) Pub. Date: Sep. 12, 2024

(54) BALL SCREW DRIVE FOR AN ACTUATOR ASSEMBLY AND METHOD FOR PRODUCING A BALL SCREW DRIVE

(71) Applicant: ZF Active Safety GmbH, Koblenz (DE)

(72) Inventors: Marco Becker, Oberduerenbach (DE); Michael Weins, Muenstermaifeld (DE); Jonathan Bockmuehl, Melsbach (DE); Christophe Jean Daniel Beyer, Weitersburg (DE)

(21) Appl. No.: 18/591,321

(22) Filed: Feb. 29, 2024

(30) Foreign Application Priority Data
Mar. 7, 2023 (DE) 102023105667.0

(51) Int. Cl. F16D 65/14; F16D 125/40; F16H 25/22; F16H 25/24

(52) U.S. Cl. CPC F16D 65/14; F16H 25/2214; F16H 25/24; F16D 2125/40; F16D 2250/0046; F16H 2025/249

(57) ABSTRACT

A ball screw drive for an actuator assembly of a vehicle brake is disclosed, comprising a rotatably mounted ball screw shaft on which a ball nut, which is open axially on one side, is mounted, wherein at least one thread is formed on a circumferential face of the ball screw shaft and a corresponding thread is formed on an inner face of the ball nut, wherein a large number of balls is guided in the threads in such a way that rotation of the ball screw shaft causes axial displacement of the ball nut along an axis of rotation of the ball screw shaft. The ball nut has a corrosion protection coating on an exterior thereof, at least on an end face thereof and in a region of a circumferential wall adjacent to the end face. A method for producing a ball screw drive is disclosed.

### CROSS-REFERENCE TO RELATED APPLICATION

This application claims priority to German Priority Application No. 102023105667.0, filed Mar. 7, 2023, the disclosure of which is incorporated herein by reference in its entirety.

### TECHNICAL FIELD

The disclosure relates to a ball screw drive for an actuator assembly of a vehicle brake, for example for an electromechanically actuated brake. The ball screw drive has a ball screw shaft on which a ball nut is mounted. In addition, the disclosure relates to a method for producing a ball screw drive.

### BACKGROUND

The ball nuts used in ball screw drives are usually hardened to ensure sufficiently high resistance to the contact stresses which arise in the region of a thread containing the balls.

In an actuator assembly for a vehicle brake, the ball nut forms the brake piston. This means that the ball nut projects partially into a gap in a disc brake caliper in order to apply a brake pad to a brake rotor. As a result, the ball nut is exposed to environmental influences, for example moisture, such as saline water spray, which promotes corrosion of the ball nut.

It is therefore necessary to provide the ball nut with adequate corrosion protection.

The disadvantage here is that, having previously undergone a hardening process, the surface structure is modified by conventional coating processes for applying corrosion protection, causing the material at the surface to become softer or porous. As a result, ball nuts with corrosion protection are less resistant to contact stress in the region of the thread, and as a result the ball nut is consequently subject to faster wear.

### SUMMARY

What is needed is a ball screw drive for an actuator assembly of a vehicle brake which is optimized in terms of the corrosion resistance and contact stress resistance thereof.

A ball screw drive for an actuator assembly of a vehicle brake is disclosed, with a rotatably mounted ball screw shaft on which a ball nut, which is open axially on one side, is mounted. At least one thread is formed on the circumferential face of the ball screw shaft and a corresponding thread is formed on the inner face of the ball nut, wherein a large number of balls is guided in the threads in such a way that rotation of the ball screw shaft causes axial displacement of the ball nut along an axis of rotation of the ball screw shaft. The ball nut has a corrosion protection coating on the exterior thereof, at least on the end face thereof and in a region of the circumferential wall adjacent to the end face. Specifically, the ball nut has a corrosion protection coating at least in the region which, when the ball screw drive is used in an actuator assembly, projects into a gap in the disc brake caliper and is therefore exposed to environmental influences.

The corrosion protection coating provides the ball nut with sufficient resistance to environmental influences when used as a brake piston. The advantage of using a corrosion protection coating is that the latter can be applied in selected sections, and therefore regions subject to elevated contact stress can remain free of corrosion protection coating to avoid adversely affecting the resistance of the material through the use of the corrosion protection.

The corrosion protection coating is formed for example by an abrasion-resistant anti-friction coating. This makes it possible to simultaneously improve the anti-friction properties of the ball nut by means of the corrosion protection coating.

The ball nut is produced for example from martensitic stainless steel.

According to an exemplary arrangement, the circumferential wall of the ball nut is coated in its entirety with the corrosion protection coating. This makes it possible for the coating process to be particularly simple. For example, the inner wall of the ball nut may be covered with a plug during the coating process.

The ball nut is designed without a corrosion protection coating on the radial inner face. This means that the ball nut does not have a corrosion protection coating in the region of the thread. The surface structure in the region of the thread is therefore not adversely affected by the corrosion protection, and so sufficient resistance is provided to the contact stresses which arise, these being Hertzian contact stresses.

The contract stresses are caused by axial and radial forces when the vehicle brake is actuated.

In one exemplary arrangement, the ball nut is hardened at least in the region of the thread. This further improves resistance to contract stresses.

The ball nut is a single, one-piece component.

A method for producing a ball screw drive is also disclosed. In a method step, a ball nut is provided, which is open axially on one side and on the inner face of which a thread is formed. A corrosion protection coating is applied to the exterior of the ball nut, at least on the end face of the ball nut and in a region of the circumferential wall adjacent to the end face. As already described with reference to the ball screw drive, the use of a corrosion protection coating provides the ball nut with sufficient protection against environmental influences while simultaneously maintaining the resistance thereof.

The ball nut is for example case-hardened before the corrosion protection coating is applied, i.e. the ball nut is initially hardened in its entirety and the corrosion protection coating is applied following the hardening process. This order avoids a reduction in corrosion protection caused by the hardening process.

Alternatively, the ball nut may be induction hardened on the inner face in the region of the thread. In induction hardening, solely the region to be hardened is heated to the required hardening temperature, wherein the duration of the heat treatment may be relatively short. This achieves a high level of resistance of the ball nut. For example, the rolling fatigue strength of the ball nut can be improved in comparison with a case-hardened ball nut.

The disclosure further relates to a brake piston for a vehicle brake comprising a ball screw drive according to the disclosure or a ball screw drive produced according to the disclosure, wherein the ball nut of the ball screw drive forms the brake piston.

### BRIEF DESCRIPTION OF DRAWINGS

Further advantages and features of the disclosure are found in the following description and in the accompanying drawings, to which reference is made. In the drawings:

FIG. 1 shows an actuator assembly with a ball screw drive according to the disclosure,

FIG. 2 shows the ball screw drive of the actuator assembly from FIG. 1, and

FIG. 3 shows an alternative ball screw drive.

### DETAILED DESCRIPTION

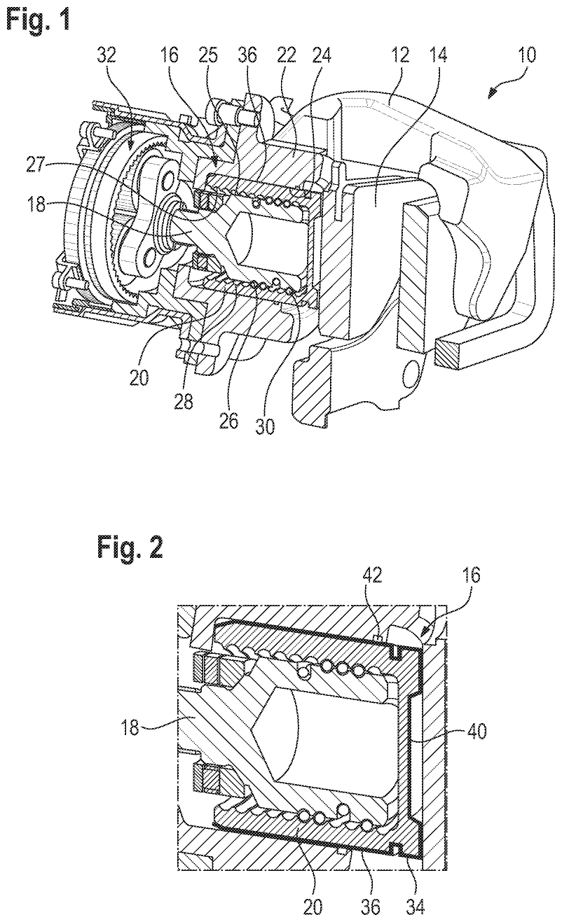

FIG. 1 shows an actuator assembly 10 for a vehicle brake.

The actuator assembly 10 comprises a disc brake caliper 12, in which a gap 14 for a brake rotor is formed.

In addition, the actuator assembly 10 comprises a ball screw drive 16 with a rotatably mounted ball screw shaft 18, on which a ball nut 20, which is open on one side, is mounted.

In the disc brake caliper 12, a sleeve-shaped portion 22 is configured, on which a bearing surface 24 is formed for the ball nut 20.

The ball nut 20 forms a brake piston which acts to apply a brake pad 21 to the brake rotor.

The ball nut 20 is displaced axially by rotating the ball screw shaft 18.

Specifically, at least one thread 26 is formed on the circumferential face 25 of the ball screw shaft 18 and a corresponding thread 28 is formed on the inner face 27 of the ball nut 20, wherein a large number of balls 30 is guided in the threads 26, 28 in such a way that rotation of the ball screw shaft 18 causes axial displacement of the ball nut 20 along an axis of rotation of the ball screw shaft 18.

In order to drive the ball screw shaft 18, an electric motor (not visible in FIG. 1) is provided, which is coupled to the ball screw shaft 18 via a gear mechanism 32.

As shown in FIG. 1, the ball nut 20 projects into the gap 14 and therefore has a partly exposed outer face. The exposed outer face is exposed to environmental influences such as moisture.

Corrosion protection is provided so as to make the ball nut 20 resistant to environmental influences.

This is achieved by a corrosion protection coating 34, which is applied to the exterior of the ball nut 20.

FIG. 2 shows the corrosion protection coating 34, wherein the coating is shown with an exaggerated thickness for illustrative purposes.

In the exemplary arrangement according to FIG. 2, a circumferential wall 36 of the ball nut, or brake piston, 20 is coated in its entirety with the corrosion protection coating 34.

In contrast, the ball nut 20 is designed without a corrosion protection coating 34 on the radial inner face 27, on which the thread 28 is also formed.

The ball nut 20 is hardened at least in the region of the thread 28.

The ball nut 20 is for example a case-hardened component, wherein the ball nut 20 is case-hardened in a production process, preferably before the corrosion protection coating 34 is applied.

Alternatively, the ball nut 20 may be induction hardened on the inner face 27 in the region of the thread 28. In this case, the corrosion protection coating 34 may be applied to the ball nut 20 both prior to and following the hardening process.

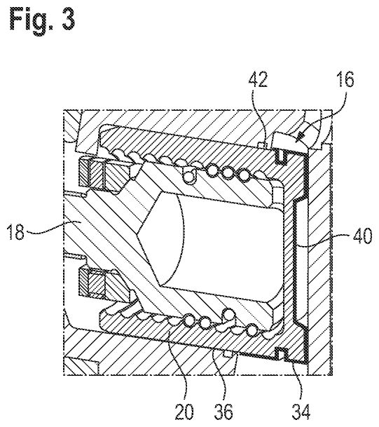

FIG. 3 illustrates an alternative arrangement of the ball screw drive 16.

The ball screw drive 16 shown in FIG. 3 differs from the ball screw drive 16 shown in FIG. 2 in that the corrosion protection coating 34 on the circumferential wall 36 does not extend over the entire axial length of the ball nut, or brake piston, 20.

Rather, the corrosion protection coating 34 is applied merely to the end face 40 of the ball nut 20 and in a region of the circumferential wall 36 adjacent to the end face 40.

The corrosion protection coating 34 is therefore only provided in the region which actually projects into the gap 14. This reduces the amount of coating material used.

In other words, the circumferential wall 36 is uncoated in a region of contact of a sealing web 42 and in an axial end region of the ball nut 20 remote from the gap 14. These regions are likewise subject to elevated contract stresses. Configuring the corresponding regions without a corrosion protection coating 34 ensures that the material of the ball nut 20 can withstand the contract stresses which arise.

1. A ball screw drive for an actuator assembly of a vehicle brake, with a rotatably mounted ball screw shaft, on which a ball nut, which is open axially on one side, is mounted,
wherein at least one thread is formed on a circumferential face of the ball screw shaft and a corresponding thread is formed on an inner face of the ball nut, wherein a number of balls is guided in the threads in such a way that rotation of the ball screw shaft causes axial displacement of the ball nut along an axis of rotation of the ball screw shaft,
wherein the ball nut has a corrosion protection coating on an exterior thereof, at least on an end face thereof and in a region of a circumferential wall adjacent to the end face.

2. The ball screw drive according to claim 1, wherein the circumferential wall of the ball nut is coated in its entirety with the corrosion protection coating.

3. The ball screw drive according to claim 1, wherein the ball nut is designed without a corrosion protection coating on the radial inner face.

4. The ball screw drive according to claim 1, wherein the ball nut is hardened at least in a region of the thread.

5. The ball screw drive according to claim 1, wherein the ball nut is configured as one piece.

6. A method for producing a ball screw drive, comprising the following steps:
providing a ball nut, which is open axially on one side and on an inner face of which a thread is formed, and
applying a corrosion protection coating to an exterior of the ball nut.

7. The method for producing a ball screw drive according to claim 6, wherein the ball nut is case-hardened before the corrosion protection coating is applied.

8. The method for producing a ball screw drive according to claim 6, wherein the ball nut is inductively hardened on the inner face in a region of the thread.

9. A brake piston for a vehicle brake, comprising a ball screw drive according to claim 1, wherein the ball nut of the ball screw drive forms the brake piston.

10. The ball screw drive according to claim 2, wherein the ball nut is designed without a corrosion protection coating on the radial inner face.

11. The ball screw drive according to claim 10, wherein the ball nut is hardened at least in a region of the thread.

12. The ball screw drive according to claim 11, wherein the ball nut is configured as one piece.

13. The method of claim 6, wherein applying a corrosion protection coating to the exterior of the ball nut further comprises applying the corrosion protection coating to at least on the end face of the ball nut and in a region of the circumferential wall adjacent to the end face.

14. The method for producing a ball screw drive according to claim 13, wherein the ball nut is case-hardened before the corrosion protection coating is applied.

15. The method for producing a ball screw drive according to claim 7, wherein the ball nut is inductively hardened on the inner face in a region of the thread.
